(19) United States
(12) Patent Application Publication
(10) Pub. No.: US 2017/0062831 A1
(43) Pub. Date: Mar. 2, 2017

(54) METAL FOIL WITH CONDUCTIVE LAYER AND METHOD OF ITS MANUFACTURING

(71) Applicant: MCD Technologies S.a r.l., Bertrange (LU)

(72) Inventors: Mikhail Rudolfovich Predtechenskiy, Novosibirsk (RU); Oleg Filippovich Bobrenok, Novosibirsk (RU); Andrey Gennadievich Kosolapov, Novosibirsk (RU)

(73) Assignee: MCD Technologies S.a r.l., Bertrange (LU)

(21) Appl. No.: 15/307,351

(22) PCT Filed: Apr. 15, 2015
(86) PCT No.: PCT/RU2015/000244

§ 371 Date: Oct. 27, 2016

(30) Foreign Application Priority Data
May 22, 2014 (RU) 2014120780

(51) Int. Cl. H01M 4/66; H01G 11/36; H01M 10/0525; H01G 11/68

(52) U.S. Cl. CPC H01M 4/663; H01G 11/68; H01G 11/36; H01M 4/661; H01M 10/0525

(57) ABSTRACT

A metal foil has a surface with an added conductive layer comprising carbon nanotubes, wherein the conductive layer is applied so that the carbon nanotubes are arranged on the foil surface randomly and in an amount of 100 ng/cm²-10 μg/cm².

A method for manufacturing the metal foil with a conductive layer of carbon nanotubes includes mixing carbon nanotubes with a solvent to form a suspension, applying the resulting suspension onto the metal foil surface so that the amount of carbon nanotubes on the surface is 100 ng/cm²-10 μg/cm² and they are arranged randomly, and then drying the suspension.

### CROSS-REFERENCE TO RELATED APPLICATIONS

This application is a US National Phase of PCT/RU2015/000244, filed Apr. 14, 2015, which claims priority to Russian Patent Application No. 2014120780, filed May 22, 2014, incorporated by reference herein in their entirety.

### BACKGROUND OF THE INVENTION

Field of the Invention

The invention relates to electrically conductive components and methods of their manufacturing.

Description of the Related Art

Design of electrochemical power sources, such as lithium-ion batteries and supercapacitors, requires a pair of electrodes. These electrodes are composed of an active electrode layer and an adjacent current collector made of a metal foil.

One of the challenges in manufacturing of such electrodes is the internal resistance of the electrode, which leads to energy losses and thereby reduces the performance of power sources. The internal resistance of the electrode, in addition to other factors, is affected by the contact resistance between the active electrode layer and the current collector.

Various technological solutions are employed to reduce this resistance; in particular, a special conductive layer contacting the active electrode layer is formed on the surface of the current collector.

For example, a lithium-ion battery cathode is known, which is made of amorphous silicon, with a current collector in the form of aluminum foil coated with a non-porous titanium serving as a conductive layer (RU Patent No. 135187).

An electrode with an aluminum current collector is known, on which a several micrometers-thick oxide film is formed, through which an active electrode layer of activated carbon is attached to the current collector by introducing solid carbon granules through the film surface into the current collector, thereby reducing contact resistance between the active electrode layer and the current collector (US Pat. No. 6,191,935). The following substances are used as granules: acetylene black, powdered graphite or crystalline carbon.

Showa Denko K.K manufactures a metal foil provided with a carbon black layer and organic binding materials. Its main disadvantage is high cost, since it is 2-3 times as expensive as foil without a conductive layer, as well as a large thickness of the conductive layer.

An aluminum foil with a forest of vertically aligned carbon nanotubes on its surface is known (Journal of Power Sources 227, pp. 218-228(2013)). This foil has low contact resistance of about 0.42-0.15 mΩ/g, which makes it exceptionally attractive for use as current collectors, e.g., in high-power supercapacitors.

Its main disadvantage is high cost due to the sophisticated and costly technology of growing vertically aligned carbon nanotubes on the foil surface.

### SUMMARY OF THE INVENTION

Accordingly, the present invention is related to a metal foil with a conductive layer and a method of its manufacturing that substantially obviate one or more of the disadvantages of the related art.

In one aspect of the invention, a metal foil has a surface with a conductive layer comprising carbon nanotubes, wherein the conductive layer is applied so that the carbon nanotubes are randomly arranged on a surface of the foil surface and in an amount of 100 ng/cm²-10 μg/cm². The conductive layer comprises single wall and/or double wall carbon nanotubes. The foil is made of aluminum, or copper, or nickel, or alloys thereof. The conductive layer is formed on its surface by applying a suspension which contains carbon nanotubes and a solvent. The suspension contains a solvent from any of water, ethanol, isopropanol, toluene, organic solvent, and n-methylpyrrolidone. The suspension can also contains a dispersant from any of polyvinylpyrrolidone (PVP), polyacrylic acid (PAA), polystyrene sulfonate (PSS), carboxymethyl cellulose (CMC) and a sodium salt of CMC, lignosulfonates, ammonium salts of polymers, sodium dodecilsulfate, and sodium dodecilbensolsulponate.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows a metal foil with a conductive layer as a current collector of the electrode.

### DETAILED DESCRIPTION OF THE PREFERRED EMBODIMENTS

Reference will now be made in detail to the preferred embodiments of the present invention, examples of which are illustrated in the accompanying drawings.

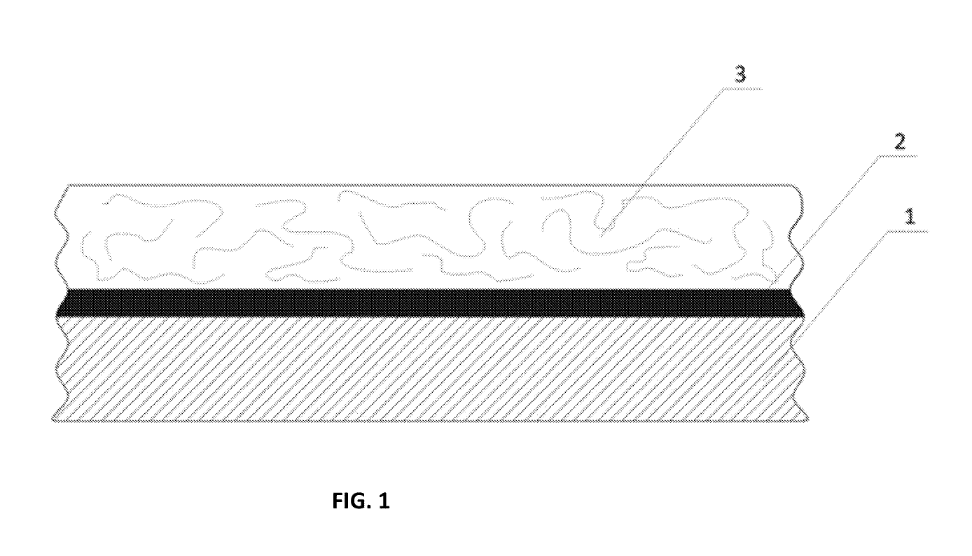

FIG. 1 shows metal foil with a conductive layer as a current collector of the electrode, where: 1 is the metal foil with a thickness of 2-80μ, 2 is the conductive layer comprising carbon nanotubes, with a thickness of 20-500 nm, 3 is the active electrode layer with a thickness of 20-160μ.

The invention thus solves the problem of creating metal foil with a conductive layer of lower cost and simpler manufacturing technology. The problem is solved by providing metal foil having a surface with a conductive layer comprising carbon nanotubes, where the conductive layer is applied onto the foil surface so that the carbon nanotubes are arranged randomly either in only two dimensions, or randomly in all three dimensions, and in an amount of 100 ng/cm²-10 μg/cm².

Carbon nanotubes may be single wall and/or double wall.

The foil may be made of aluminum, or copper, or nickel, or alloys thereof, for example, as well as of other suitable metals and alloys.

The conductive layer may be formed on the surface of the metal foil by applying thereto a suspension containing carbon nanotubes and a solvent.

The suspension may contain a solvent from the following series: water, ethanol, isopropanol, toluene, organic solvent, n-methylpyrrolidone.

Also, the suspension can further contain a dispersant—a surfactant, e.g., from the following series: polyvinylpyrrolidone (PVP), polyacrylic acid (PAA), polystyrene sulfonate (PSS), carboxymethyl cellulose (CMC) and a sodium salt of CMC, lignosulfonates, ammonium salts of polymers, sodium dodecilsulfate, and sodium dodecilbensolsulponate.

A method for manufacturing metal foil with a conductive layer comprising carbon nanotubes includes mixing carbon nanotubes with a solvent to form a suspension, applying the resulting suspension onto the metal foil surface so that the amount of carbon nanotubes thereon is 100 ng/cm²-10 μg/cm², and then drying.

Single wall and/or double wall carbon nanotubes are preferably used in manufacturing foil with a conductive layer.

Preferably, a substance from the following series can be used as a solvent: water, ethanol, isopropanol, toluene, organic solvent, n-methylpyrrolidone.

The suspension may also contain a dispersant, i.e., a substance that forms and stabilizes the suspension, which can be selected from the following series: polyvinylpyrrolidone (PVP), polyacrylic acid (PAA), polystyrene sulfonate (PSS), carboxymethyl cellulose (CMC) and a sodium salt of CMC, lignosulfonates, ammonium salts of polymers, sodium dodecilsulfate, and sodium dodecilbensolsulponate.

The proposed metal foil with a conductive layer is shown as a current collector of the electrode in FIG. 1, where 1 is the metal foil, 2 is the conductive layer comprising carbon nanotubes, and 3 is the active electrode layer.

The metal foil with a conductive layer is manufactured as follows.

The prepared single wall and/or double wall carbon nanotubes are mixed with a solvent, e.g., water. A dispersant is added, e.g., polyvinylpyrrolidone, and the mixture is dispersed ultrasonically using an ultra-sonicator, thereby producing a suspension containing carbon nanotubes. This suspension is then applied onto the foil 1 surface based on the condition that the carbon nanotubes are arranged on the surface randomly and in an amount of 100 ng/cm²-10 μg/cm². The suspension may be applied by aerosol spraying, air brush, ultrasonic spray or by any other known method suitable for this purpose.

After the metal foil surface is dried, a thin layer remains on it, the layer including carbon nanotubes 2 in an amount sufficient to ensure its good conductivity. When such a foil is used as a current collector of the electrode, the conductive layer reduces contact resistance of the current collector and the active electrode substance 3, to which the foil is attached.

The manufacturing of such foil is less expensive than of foil with a conductive layer made of a forest of carbon nanotubes, and is much simpler. Accordingly, the cost of the described foil is lower than that of the prototype.

### Example 1

The single wall and double wall carbon nanotubes are mixed with polyvinylpyrrolidone in a ratio of 50/50 wt %. Water is added to this mixture based on the content of nanotubes in the resulting mixture at a level of 0.2 wt %. The resulting mixture is dispersed using an ultra-sonicator. The resulting suspension is applied onto the surface of aluminum foil with an air brush based on consumption of the suspension of 50 to 60 mL per 1 m² of the foil area. The resulting layer on the foil surface is air-dried. The content of carbon nanotubes in the applied conductive layer is about 10 μg/cm².

When the aluminum foil with the resulting conductive layer is used as a current collector of the electrode, electrode resistance is 40Ω. When the same aluminum foil without a conductive layer is used, electrode resistance is 300Ω.

### Example 2

The single wall and double wall carbon nanotubes are mixed with polyvinylpyrrolidone in a ratio of 50/50 wt %. n-Methylpyrrolidone is added to this mixture based on the content of nanotubes in the resulting mixture at a level of 0.1 wt %. The resulting mixture is dispersed using an ultra-sonicator. The resulting suspension is applied onto the surface of aluminum foil with an air brush based on consumption of the suspension of 50 to 60 mL per 1 m² of the foil area.

The resulting layer on the foil surface is dried. The content of carbon nanotubes in the applied conductive layer is 5 μg/cm².

When the aluminum foil with the resulting conductive layer is used as a current collector of the electrode, electrode resistance is 42Ω. When the same aluminum foil without a conductive layer is used, electrode resistance is 300Ω.

### INDUSTRIAL APPLICABILITY

The proposed metal foil with a conductive layer may be used preferably in electrochemical power sources as current collectors, but its usage is not limited by this application. It can apparently find other applications as well.

Having thus described a preferred embodiment, it should be apparent to those skilled in the art that certain advantages of the described method and apparatus have been achieved.

It should also be appreciated that various modifications, adaptations, and alternative embodiments thereof may be made within the scope and spirit of the present invention. The invention is further defined by the following claims.

What is claimed is:

1. A metal foil having a surface provided with a conductive layer comprising carbon nanotubes, wherein the conductive layer is applied so that the carbon nanotubes are randomly arranged on a surface of the foil surface and in an amount of 100 ng/cm²-10 μg/cm².

2. The metal foil of claim 1, wherein the conductive layer comprises single wall and/or double wall carbon nanotubes.

3. The metal foil of claim 1, wherein the foil is made of aluminum, or copper, or nickel, or alloys thereof.

4. The metal foil of claim 1, wherein the conductive layer is formed on its surface by applying a suspension which contains carbon nanotubes and a solvent.

5. The metal foil of claim 4, wherein the suspension contains a solvent from the following set: water, ethanol, isopropanol, toluene, organic solvent, n-methylpyrrolidone.

6. The metal foil of claim 4, wherein the suspension further contains a dispersant from the following set: polyvinylpyrrolidone (PVP), polyacrylic acid (PAA), polystyrene sulfonate (PSS), carboxymethyl cellulose (CMC) and a sodium salt of CMC, lignosulfonates, ammonium salts of polymers, sodium dodecilsulfate, and sodium dodecilbensolsulponate.

7. A method for manufacturing metal foil with a conductive layer on the its surface, wherein a layer of suspension containing carbon nanotubes and a solvent is applied onto the foil surface so that the amount of nanotubes on the surface is 100 ng/cm²-10 μg/cm² and the nanotubes are arranged randomly, and then the applied suspension layer is dried.

8. The method of claim 7, wherein the suspension includes single wall and/or double wall carbon nanotubes.

9. The method of claim 7, wherein the suspension contains a solvent from the following set: water, ethanol, isopropanol, toluene, organic solvent, n-methylpyrrolidone.

10. The method of claim 7, wherein the suspension further contains a dispersant from the following set: polyvinylpyrrolidone (PVP), polyacrylic acid (PAA), polystyrene sulfonate (PSS), carboxymethyl cellulose (CMC) and a sodium salt of CMC, lignosulfonates, ammonium salts of polymers, sodium dodecilsulfate, and sodium dodecilbensolsulponate.

11. The method of claim 7, wherein the metal foil is made of aluminum, copper, nickel, and/or alloys thereof.
